(19) United States
(12) Patent Application Publication
(10) Pub. No.: US 2009/0322791 A1
(43) Pub. Date: Dec. 31, 2009

(54) APPARATUS AND METHOD FOR TOUCH SCREEN EDITING OF DIGITAL IMAGES

(75) Inventor: WEN-YI WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/240,021

(22) Filed: Sep. 29, 2008

(30) Foreign Application Priority Data
Jun. 27, 2008 (CN) 200810302398.9

(51) Int. Cl. G09G 5/00; G06F 3/041

(52) U.S. Cl. 345/660; 345/173

(57) ABSTRACT

An apparatus for displaying various aspects of images according to a user's operation includes a touch screen display on which an image is displayed, a compressing module supporting a compressing mode for displaying a portion of an image with a compressed appearance, a stretch module for displaying a portion of an image with a stretched appearance, an object insertion module for adorned a displayed image with props displayed on the touch screen display; and a doodle module for adding doodles to a displayed image.

### BACKGROUND

1. Technical Field

The present invention generally relates to an apparatus for and method of editing images according to a user's manipulation of a touch screen display.

2. Description of Related Art

Touch screen technology is widely used in electronic consumer products, such as personal digital assistants (PDAs), smart phones, digital photo frames (DPFs) etc. For example, a typical DPF has a touch screen display, which acts as a graphical user interface. The graphical user interface provides a selection of labeled, virtual control buttons, each of which can activate a function or mode when touched by a user. For example, a user can touch a virtual button labeled “next” to display a next image stored in the DPF. However, typically, images displayed on the touch screen display cannot be directly edited using the touch of a finger.

Therefore, there is room for improvement within the art.

### BRIEF DESCRIPTION OF THE DRAWINGS

FIG. 1 is a schematic/block diagram of an embodiment of an apparatus for providing various image editing functions through the use of a touch screen;

FIG. 2 is a flow chart of a first operation of an embodiment of a method for touch screen editing of digital images;

FIG. 3 is a flow chart of a second operation of the method for touch screen editing of digital images;

FIG. 4 is a flow chart of a third operation of the method for touch screen editing of digital images;

FIG. 5 is a flow chart of a fourth operation of the method for touch screen editing of digital images; and

FIG. 6 is a flow chart of a fifth operation of the method for touch screen editing of digital images.

### DETAILED DESCRIPTION OF THE EMBODIMENTS

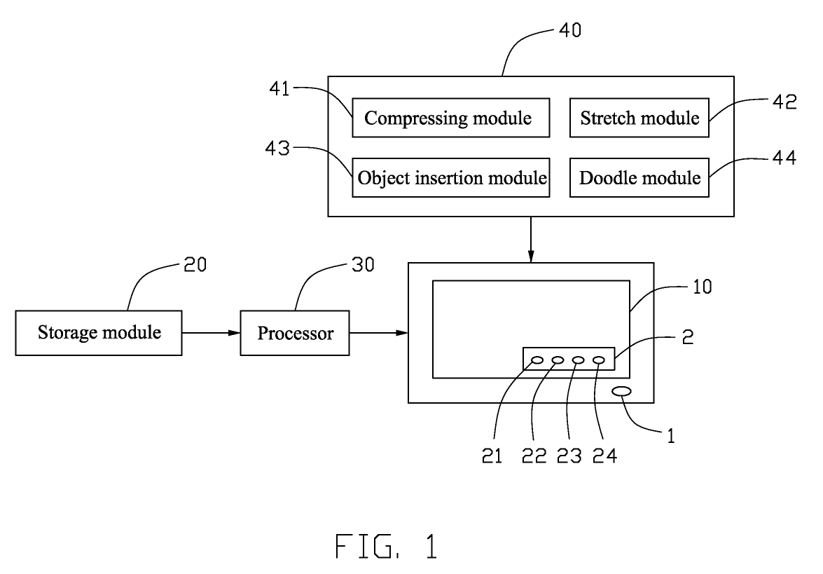

Referring to FIG. 1, an exemplary embodiment of an apparatus for touch screen editing of digital images includes a touch screen display 10, a storage module 20 for storing images therein, a processor 30 for, among other things, instructing the touch screen display 10 to display an image, and an editing module 40 capable of supporting different editing modes. For example, the editing module 40 may include a first distortion (e.g., compressing) module 41, a second distortion (e.g., stretch) module 42, an object insertion module 43, and a doodle module 44. The DPF further includes a mechanical button 1 for enabling or disabling the touch sensitivity of the touch screen display 10, and a virtual button region 2 capable of displaying virtual buttons. The virtual button region 2 includes a first virtual button 21 corresponding to the compressing module 41, a second virtual button 22 corresponding to the stretch module 42, a third virtual button 23 corresponding to the object insertion module 43, and a fourth virtual button 24 corresponding to the doodle module 44.

In use, the mechanical button 1 is pressed for enabling the touch sensitivity function of the touch screen display 10 and activating the virtual button region 2. If a user touches the first virtual button 21, the compressing module 41 is enabled for providing a compressing mode. In the compressing mode, the user can touch a portion of the displayed image causing that portion to have a compressed appearance. For example, if a portion of a displayed image corresponding to a person's nose is touched by the user, the nose in the image will changed to have a compressed appearance. If the second virtual button 21 is pressed, the stretch module 42 is enabled for providing a stretch mode. In the stretch mode, the user can stretch a portion of an image displayed on the touch screen display 10. For example, if the user traces portions of a displayed image corresponding to the corners of a person's lip, the corners can appear as stretched into a semblance of a smile or an exaggerated smile or grimace. If the third virtual button 23 is pressed, the object insertion module 43 is enabled. In the object insertion mode, a prop list, or in other embodiments, images of props, is displayed on the touch screen display 10. The prop list may include hair portions each in a different style and color, eyeglasses, clothing items, smiling lips, laughing mouth, etc., or images of same, which can be selected for insertion into the image in a position and orientation indicated by the user with a touch of the touch screen display 10. For example, the user can chose to add eyeglasses to the person in the image. If the fourth virtual button 24 is pressed, the doodle module 44 is enabled for providing a doodle mode. In the doodle mode, the user can scribble on the touch screen display 10 to doodle over the subjects in the image. A variety of fonts, colors etc. can be provide for the doodle mode.

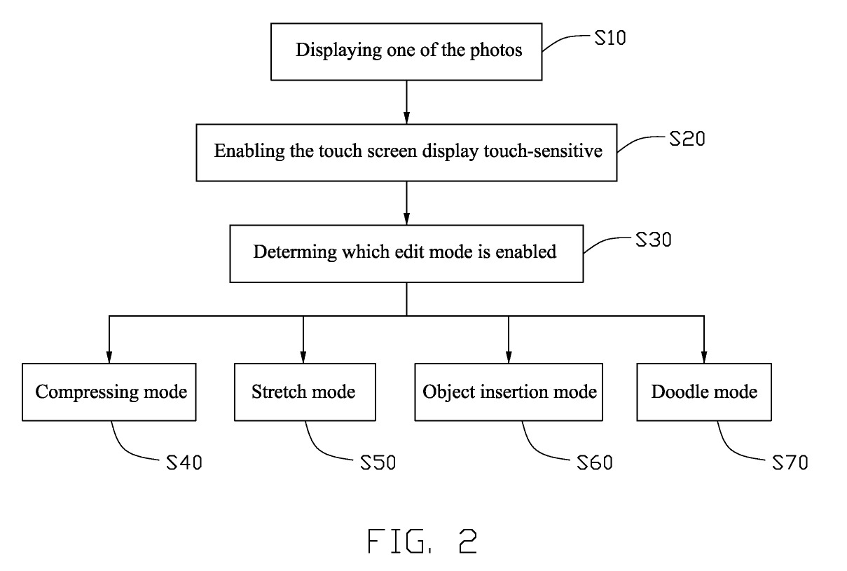

FIGS. 2-6, are flowcharts depicting use of the above described apparatus. Depending on the embodiment, certain steps described below may be removed, others may be added, and/or the sequence of steps may be altered.

In block S10, an image stored in the storage module 20 is displayed on the touch screen display 10;

In block S20, the mechanical button 1 is pressed to enable the touch sensitivity function of the touch screen display 10;

In block S30, selected editing mode is determined and enabled;

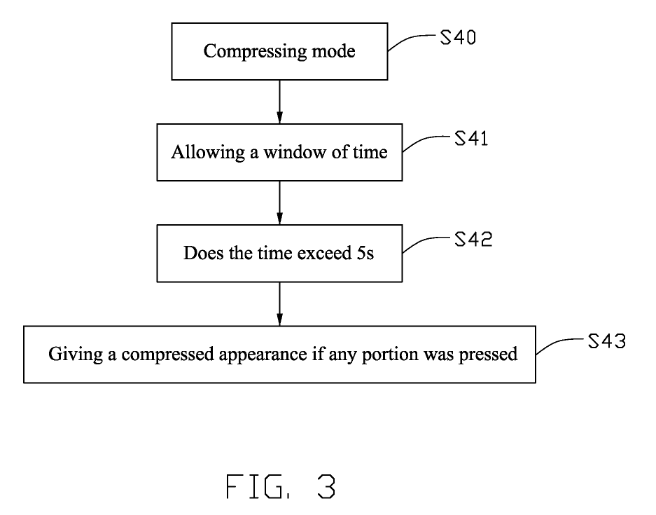

In block S40, if the compressing mode is selected and enabled (See FIG. 3), the processor 30 allows a window of time in which the touch screen display 10 is responsive to touch in the compressing mode (S41); once the processor 30 determines the time window has expired, for example, 5 seconds (S42), pixels located at the pressed portion, if any portion was pressed, of the displayed image are altered to give a compressed appearance;

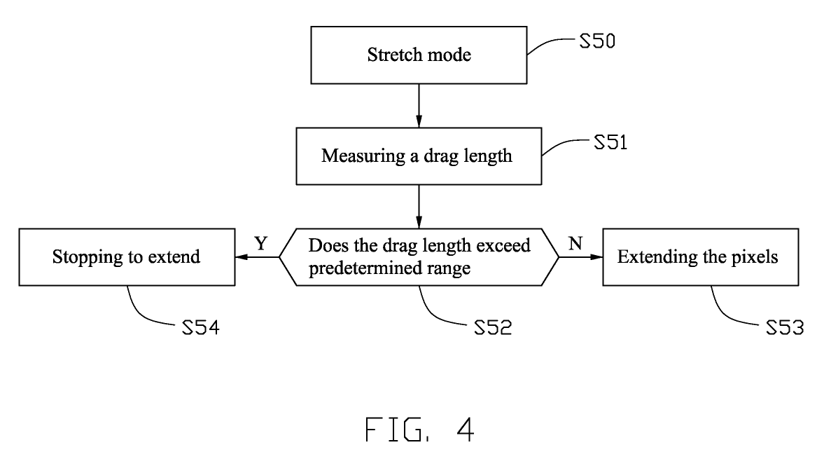

In block S50, if the stretch mode is selected and enabled (see FIG. 4), a length of a stretch path traced on the touch screen display 10 by the user is measured (S51) by the processor 30 to determine whether the path exceeds a predetermined limit (S52), e.g., 20% of a width of the touch screen display 10; if the stretch length does not exceed the predetermined limit, pixels of the traced region are altered to give a stretched appearance (S53) to that portion of the image; if the stretch path length does exceed the predetermined limit, pixel stretching is stopped and the user may be prompted to try again (S54);

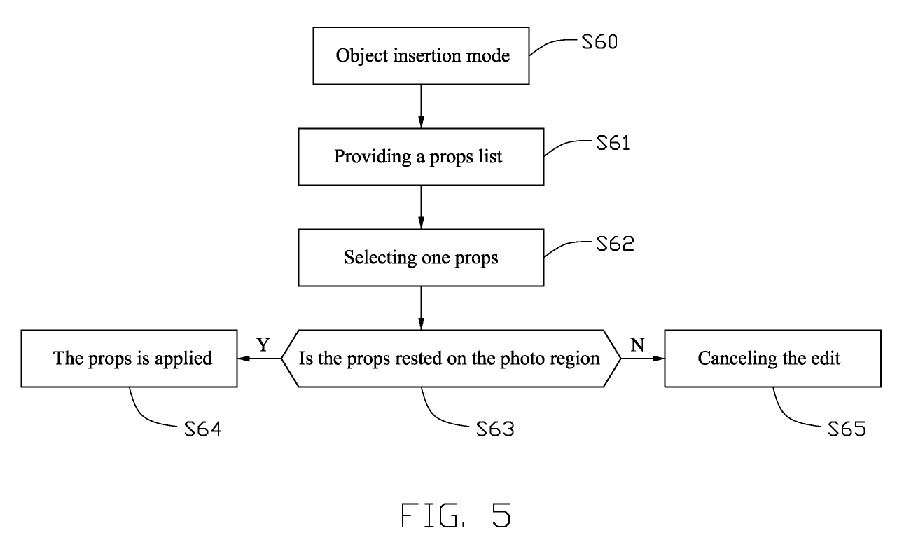

In block S60, if the object insertion mode is selected and enabled (See FIG. 5), the prop list is displayed on the touch screen display 10 (S61); if a prop is selected by touch (S62), the processor 30 inserts the prop in an area of the image where touching elements are absent from the touch screen (S64); then the user touches the image where they want the prop positioned, and the prop is positioned at that location (S65), then further touches may allow the user to selectively orient the prop, for example rotating a hair portion clockwise by degrees with each touch to achieve a desired alignment of the hair portion relative to the head of a subject the hair portion is applied to in the image (S66); if the prop is not positioned by a touch in the image area, the action is canceled and the user may be prompted to try again (S67);

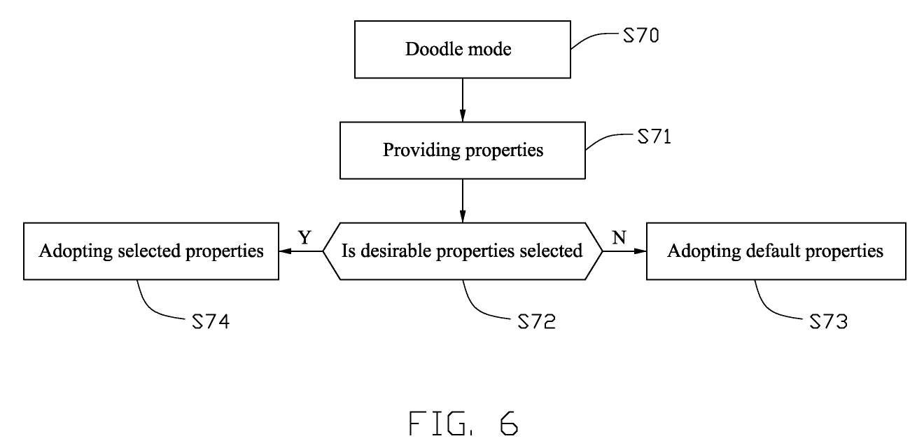

In block S70, if the doodle mode is enabled (See FIG. 6), property selections (e.g. font/color) may be displayed on the touch screen display 10 (S71); the processor 30 determines what properties are selected if any (S72); if properties are not selected, default properties are adopted when the user doodles on the touch screen display 10 (S73); if properties are selected, the selected properties are used when the user doodles on the touch screen display 10 (S74) to draw over portions of the displayed image.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What is claimed is:

1. An apparatus comprising:
a touch screen display on which an image can be displayed;
a compressing module supporting a compressing mode in which a portion of an image displayed on the touch screen display can be displayed with a compressed appearance;
a stretch module supporting a stretch mode in which a portion of an image displayed on the touch screen display can be displayed with a stretched appearance;
an object insertion module supporting an object insertion mode in which a displayed image is capable of being displayed with props; and
a doodle module supporting a doodle mode in which a displayed image is capable of having doodling displayed upon.

2. The apparatus of claim 1, wherein the compressing module, the stretch module, the object insertion module, and the doodle module each correspond to a virtual button on the touch screen display; wherein when a virtual button is pressed, the corresponding module is enabled.

3. The apparatus of claim 2, further comprising a mechanical button for enabling or disabling the touch sensitivity of the touch screen display; wherein the virtual buttons are displayed on the touch screen display when the touch sensitivity of the touch screen is enabled.

4. The apparatus of claim 1, further comprising a storage module for storing the image, and a processor for instructing the touch screen display to display the image.

5. The apparatus of claim 1, wherein the touch screen display is a part of a digital data photo frame.

6. A method for touch screen editing of a displayed image, comprising:
using a compressing editing mode to display a pressed portion of the displayed image with a compressed appearance;
using a stretch editing mode to display a traced portion of the displayed image with a stretched appearance;
using an object insertion mode to display a prop with the displayed image; and
using doodle editing mode to add doodles to the displayed image.

7. The method of claim 6, wherein the step of displaying the image with a compressed appearance comprises allowing a window of time in which the touch screen display 10 is responsive to touch in the compressing mode.

8. The method of claim 6, wherein the step of displaying the image with a stretched appearance comprises stretching pixels of a traced region of the displayed image until a predetermined stretch length is exceeded.

9. The method of claim 8, wherein the predetermined stretched length is 0-20% of a width of the touch screen display.

10. The method of claim 6, wherein the list of props includes a list of hair colors and styles, eyeglasses, clothes, smile lips, and laugh lips which can be applied to the image.

11. The method of claim 6, wherein the step of showing the photo with the doodles comprising providing different fonts and colors for the doodles being added to the image.
